(19) United States
(12) Patent Application Publication
(10) Pub. No.: US 2016/0350217 A1
(43) Pub. Date: Dec. 1, 2016

(54) APPARATUSES AND METHODS FOR PROVIDING DATA CONSISTENCY MESSAGING FOR SHARED MEMORY SYSTEMS

(71) Applicant: Magnum Semiconductor, Inc., Milipitas, CA (US)

(72) Inventor: Jens A. Roever, Los Gatos, CA (US)

(21) Appl. No.: 14/721,967

(22) Filed: May 26, 2015

(51) Int. Cl. G06F 12/08

(52) U.S. Cl. CPC G06F 12/084; G06F 12/0842; G06F 12/0815; G06F 2212/1008; G06F 2212/1041; G06F 2212/281; G06F 2212/621

(57) ABSTRACT

Apparatuses and methods for providing data consistency messaging for shared memory systems are disclosed herein. An example apparatus may include a producer processor unit configured to provide a memory access packet and a first notification packet. The first notification packet may include identification of a consumer processor unit. The example apparatus may further include a shared resource configured to receive the memory access packet and the notification packet. Responsive to reception of the memory access packet, the shared resource may be configured to perform a memory access operation. Responsive to reception of the notification packet, the shared resource may be further configured to route a first notification packet to the consumer processor unit. The second notification packet may include information indicating the shared resource is available.

### TECHNICAL FIELD

Embodiments of this disclosure relate generally to shared memory systems, and examples of providing data consistency messaging for shared memory systems are described herein.

### BACKGROUND

In an effort to improving processing speed and capacity, multiple core processing systems have been implemented in a many systems to facilitate parallel processing of data. In some multi-core architectures, data may be shared between the multiple processor cores using a shared resource. In this case, data may be shared between the multiple processor cores via use of addressable memory locations (e.g., a buffer) mapped to a shared memory resource (e.g., a memory controller). Therefore, data can be stored at and accessed at the buffer at a time convenient for a processor core.

However, in order for data exchanges between a producing processor core (e.g., storing data at the shared memory location) and a consuming processor core (e.g., accessing data at the shared memory location) to generate consistent results, data ordering rules have to be enforced such that data is not consumed (e.g., accessed) before being stored at the shared memory location. The ordering rules may have a synchronizing effect on the producing processor core and consuming processor core. In some systems, the processor cores may play an active role in the data synchronization. For example, a producing processor core may send data to be stored at the shared memory resource. Upon receiving notification from the shared memory resource that the data was stored, the producing processor core may provide a notification to one or more consuming processor cores that the data is ready to be accessed. However, participation of the processor cores in the data synchronization process may increase the processing overhead and thus reduce the amount of compute cycles available to the processor cores' main processing function(s). In other systems, the data synchronization may be controlled at a system level, rather than by the processor cores. However, enforcing rigid data consistency at the system level may lead to increased, and sometimes excessive, system costs and complexity for larger multiple core systems.

### BRIEF DESCRIPTION OF THE DRAWINGS

FIG. 1 is a block diagram of an apparatus including a shared memory according to an embodiment of the present disclosure.

FIG. 2 is a block diagram of an apparatus including a shared memory according to an embodiment of the present disclosure.

FIG. 3 is a block diagram of an apparatus including a shared memory according to an embodiment of the present disclosure.

FIG. 4 is a flowchart of a method for providing data consistency messaging in a shared memory system according to an embodiment of the present disclosure.

FIG. 5 is a schematic illustration of a media delivery system according to an embodiment of the present disclosure.

FIG. 6 is a schematic illustration of a video distribution system that may make use of apparatuses described herein.

### DETAILED DESCRIPTION

Examples of apparatuses and methods for data consistency messaging in shared memory systems are described herein. Certain details are set forth below to provide a sufficient understanding of embodiments of the disclosure. However, it will be clear to one having skill in the art that embodiments of the disclosure may be practiced without these particular details, or with additional or different details. Moreover, the particular embodiments of the present disclosure described herein are provided by way of example and should not be used to limit the scope of the disclosure to these particular embodiments. In other instances, well-known video components, encoder or decoder components, circuits, control signals, timing protocols, and software operations have not been shown in detail in order to avoid unnecessarily obscuring the disclosure.

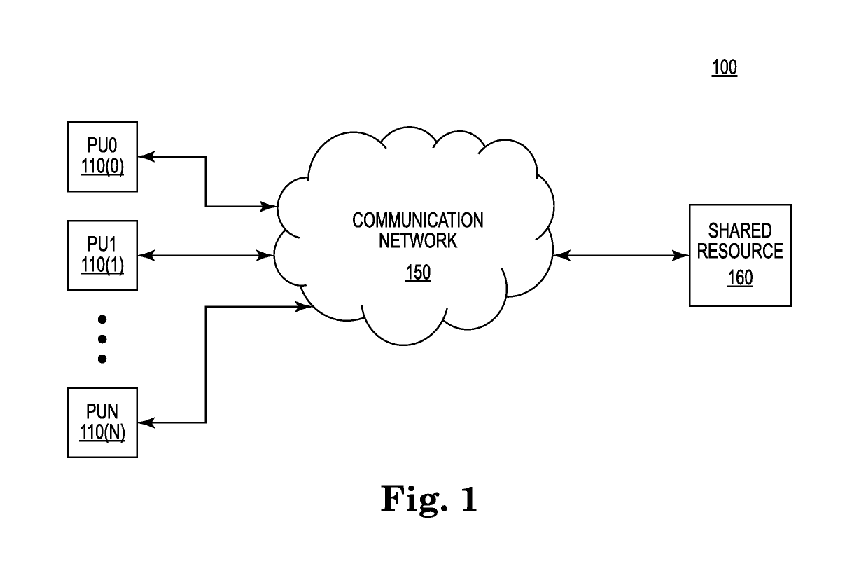

FIG. 1 is a block diagram of an apparatus 100 according to an embodiment of the present disclosure. The apparatus 100 may include processor units 110(0-N) coupled to a shared resource 160 via a communication network 150. Each of the processor units 110(0-N) may store and access data at the shared resource 160. The processor units 110(0-N) may all be formed on single chip, formed on different chips, or combinations thereof. In some embodiments, each of the processor units 110(0-N) may have an associated cache (e.g., a level 1 cache), and may be configured to operate according to an instruction set architecture (ISA). In some embodiments, the processor units 110(0-N) are homogenous (e.g., are all identical processor units). In other examples, the processor units 110(0-N) are heterogeneous (e.g., the processor cores are not identical). The processor units 110(0-N) may include any number of processor units. In some examples, the number of processor units is a power of two multiple. Each of the processor units 110(0-N) may be designed to perform any function that includes production of data and consumption of data from storage.

The shared resource 160 (e.g., shared memory) may include any type of memory, such as non-volatile memory (e.g., NAND or NOR flash, non-volatile random-access memory (RAM), hard drive memory, etc.), volatile memory (e.g., dynamic RAM (DRAM (e.g., double data rate (DDR) static DRAM (SDRAM)), etc.). In some embodiments, the processor units 110(0-N) and the shared resource 160 are included on the same chip to form a system on chip (SOC). In other embodiments, the processor units 110(0-N) and the shared resource 160 are on different chips. The shared resource 160 may include a memory controller configured to receive and process access commands from the processor units 110(0-N).

The communication network 150 may include a network-on-chip, a local area network (LAN), a personal area network (PAN), system area network (SAN), or another network type capable of providing data and commands between the processor units 110(0-N) and the shared resource 160.

In operation, processor units 110(0-N) may execute instructions in the course of executing a computer program. In an example, the computer program may include parallel processing during encode or decode of video data. During execution, the processor units 110(0-N) may send access commands to the shared resource 160 to perform a memory access operation. The access commands may be provided between the processor units 110(0-N) and the shared resource 160 via access packets sent over the communication network 150. The memory access operations may include storing data at (e.g., writing data to) the shared resource 160 and/or retrieving data (e.g., read data) from the shared resource 160. For example, a processor unit of the processor units 110(0-N) may send a packet including a write command and data to the shared resource 160 via the communication network 150 to instruct a memory controller of the shared resource 160 to write the data to memory.

Because the processor units 110(0-N) may execute a computer program in parallel, in some examples, data may be shared by two or more of the processor units 110(0-N). For example, a first processing unit of the processor units 110(0-N) be configured to generate data that is to be consumed by a second processor unit of the processor units 110(0-N). The data generated by the processor units 110(0-N) may be stored at a location at the shared resource 160, and the second processor unit may wait to access the memory location storing the data until after the data has been stored. In another example, the first processing unit may access the data at the memory location, and the second processor unit may wait to update/overwrite the data at the memory location until the first processor unit has successfully accessed the data. In order to synchronize timing of data storage and data access and reduce probability of processing of incorrect data, the apparatus 100 may include notification system to notify a processor unit that the memory location is ready to be accessed.

The notification system may include a producing processor unit of the processor units 110(0-N) sending, to the shared resource 160, a memory access packet followed by a first notification packet. Each of the memory access packet and the first notification packet may be addressed to a location of the shared resource 160. In some examples, the location of the shared resource 160 may be different between the memory access packet and the first notification packet. The memory access packet may include a memory access command and information necessary to execute the memory access command (e.g., an address, data, flags, etc.) The first notification packet may include identification of the notification packet as a “notification packet” and information identifying one or more of the processor units 110(0-N) to be notified that the memory location associated with the memory access packet is available for access. In some embodiments, the producing processor unit of the processor units 110(0-N) may send a chain of notification packets after the memory access packet, with each of the chain of notification packets identifying a respective one of the processor units 110(0-N) to be notified that the memory location associated with the memory access packet is available for access

The shared resource 160 may be configured to process packets in an order received at the memory shared resource 160. Thus, because the memory access packet is sent before the first notification packet, the shared resource 160 may process the memory access packet prior to processing the first notification packet. Because the memory access packet has been processed, the data in the memory location is ready for access by the one or more processor units identified in the notification packet.

The shared resource 160 may process the first notification message to construct a second notification packet addressed to the identified one or more processor units. (e.g., from the first notification packet). The second notification message may serve to indicate that data stored at the memory location associated with the memory access packet is available for access. In some embodiments, the second notification packet may be provided to each of the identified one or more processor units. In some embodiments, the second notification packet may be provided to a respective message box associated with each of the identified one or more processor units.

By sending the notification packets via the shared resource 160 immediately after the memory access packet, overhead processing related to data synchronization may be reduced at the processor units 110(0-N), as compared with the data synchronization being managed within the individual processor units 110(0-N).

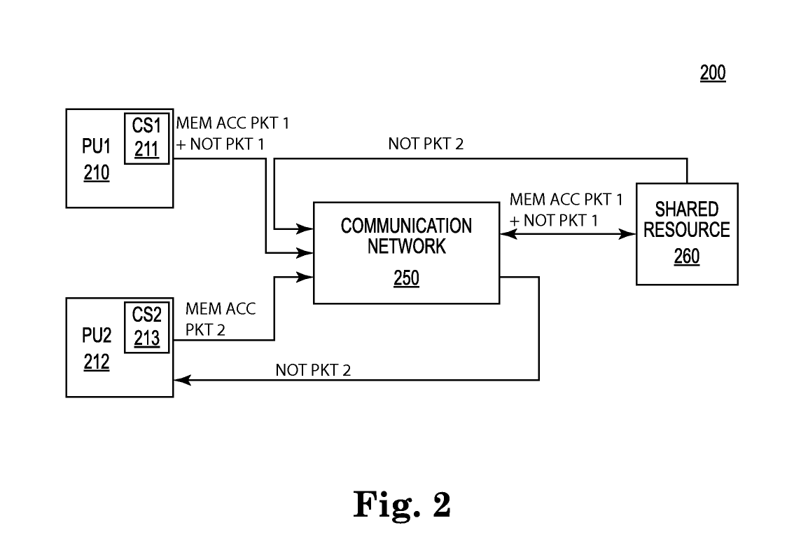

FIG. 2 is a block diagram of an apparatus 200 according to an embodiment of the present disclosure. The apparatus 200 may include a first processor unit 210 and a second processor unit 212, each coupled to a shared resource 260 via a communication network 250. Each of the first processor unit 210 and the second processor unit 212 may store and access data at the shared resource 260. The first processor unit 210 and/or the second processor unit 212 may be implemented in the processor units 110(0-N) of FIG. 1. The shared resource 260 may be implemented in the shared resource 160 of FIG. 1. The communication network 250 may be implemented in the communication network 150 of FIG. 1.

The first processor unit 210 and second processor unit 212 may all be formed on single chip, formed on different chips, or combinations thereof. In some embodiments, each of the first processor unit 210 and second processor unit 212 may have an associated cache (e.g., a level 1 cache), and may be configured to operate according to an instruction set architecture (ISA). In some embodiments, the first processor unit 210 and the second processor unit 212 may be homogenous (e.g., are identical processor units). In other examples, the first processor unit 210 and the second processor unit 212 may be heterogeneous (e.g., the processor cores are not identical). Each of the first processor unit 210 and the second processor unit 212 may be designed to perform any function that includes production of data and consumption of data that are stored at the shared memory resource.

In some embodiments, the first processor unit 210 and second processor unit 212 may include a respective control space (e.g., the control space 211 and control space 213, respectively). The control space 211 and the control space 213 may be to control various operational aspects of the first processor unit 210 and the second processor unit 212, respectively. For example, the control space 211 and/or the control space 213 may be configured to store parameters related to operating mode, processing speed, and data flow. In some examples, the control space 211 and/or the control space 213 may be store parameters that provide an indication of when an address location of the shared resource 260 is ready for access. The first processor unit 210 and/or the second processor unit 212 may perform an access of the address location of the shared resource 260 responsive to the indication of the address location being ready to access via the control space 211 or the control space 213, respectively. The control space 211 and/or the control space 213 may be updated to provide the ready for access indication responsive to a notification packet from the shared resource 260 via the communication network 250.

The shared resource 260 may include any type of memory, such as non-volatile memory (e.g., NAND or NOR flash, non-volatile random-access memory (RAM), hard drive memory, etc.), volatile memory (e.g., dynamic RAM (DRAM (e.g., double data rate (DDR) static DRAM (SDRAM)), etc.). In some embodiments, the first processor unit 210, the second processor unit 212, and the shared resource 260 are included on the same chip to form a system on chip (SOC). In other embodiments, the first processor unit 210, the second processor unit 212, and the shared resource 260 are on different chips. The shared resource 260 may include a memory controller configured to receive and process access commands from the first processor unit 210 and/or the second processor unit 212.

The communication network 250 may include a network-on-chip, a local area network (LAN), a personal area network (PAN), system area network (SAN), or another network type capable of providing data and commands between the first processor unit 210, the second processor unit 212, and the shared resource 260.

In an example operation, the first processor unit 210 and the second processor unit 212 may process data in parallel. The example operation may include the second processor unit 212 accessing data that is generated by the first processor unit 210 and stored at the shared resource 260. That is, the first processor unit 210 may be a producer processor unit (e.g., generate data to be stored at the shared resource 260) and the second processor unit 212 may be a consumer processor unit (e.g., read the data from the shared resource 260). In order to synchronize timing of data storage and data access, and to reduce probability of processing of incorrect data, the apparatus 200 may include notification system to notify the second processor unit 212 that the memory location of the shared memory resource 260 is ready to be accessed.

Thus, during execution, the first processor unit 210 may send a write command and write data to the shared resource 260 to perform a write operation. The write command and write data may be sent to the shared resource 260 via a write access packet over the communication network 250. The write access packet may include an address identifying a location at the shared resource 260 to write the data.

Following the write command, the first processor unit 210 may send a first notification packet to the shared resource 260. The first notification packet may include a notification packet type, the address location of the shared resource 260 available for access (e.g., the same address location in the write access packet), and identification of the second processor unit 212. In some embodiments, the notification packet type may include a particular address of the shared resource 260 reserved for this packet type. In other embodiments, the notification packet type may include a flag or another field of the notification packet having a value (e.g., set by the first processor unit 210) that indicates the notification packet type. The identification of the second processor unit 212 may include an address or another field that is decoded to identify the second processor unit 212.

The communication network 250 may provide packets to an input on a first in, first out basis. Thus, the communication network 250 may provide packets received from the first processor unit 210 to a recipient (e.g., the shared resource 260) in a sequential order. A memory controller of the shared resource 260 may be also configured to process received packets in a first in, first out basis. Thus, the shared resource 260 may process the write access packet prior to processing the first notification packet. Responsive to receiving the write access packet, the shared resource 260 may store the write data. In some embodiments, the shared resource 260 may verify contents of the write access packet prior to storing the write data.

Responsive to receiving the notification packet, the shared resource 260 may identify the notification packet type, and may retrieve the information identifying the second processor unit 212. The shared resource 260 may construct a second notification packet to send to the second processor unit 212 based on the information identifying the second processor unit 212 and the address location of the shared resource 260. The shared resource 260 may send the second notification packet to the second processor unit 212 via the communication network 250. In some systems the second notification packet may be sent prior to internal completion of the memory access associated with the memory access packet if the shared resource 260 can guarantee that subsequent accesses to earlier write accesses will not be executed out of order. Based on the second notification packet, the second processor unit 212 may send a read access packet to the shared resource 260 that is directed to the address location. In some embodiments, the control space 213 of the second processor unit 212 may be updated (e.g., clearing or setting of flags or other fields) with information in the second notification packet. The second processor unit 212 may use the information in the control space 213 to determine when to send the read access packet.

The first and second notification packets may be used by the apparatus 200 to synchronize access of data for two or more processor units operating in parallel. The apparatus 200 may be expanded to include any number of processor units. By sending the first notification packets to the shared resource 260, an overhead processing workload for the first processor unit 210 may be reduced as compared with a system where a producer processor unit must monitor a write command request to determine when the write command has completed processing and provide the notification to the second processor unit 212. The above operation is exemplary. A similar operation may be implemented for a read access command may be processed before a write access command for a common address location of the shared resource 260.

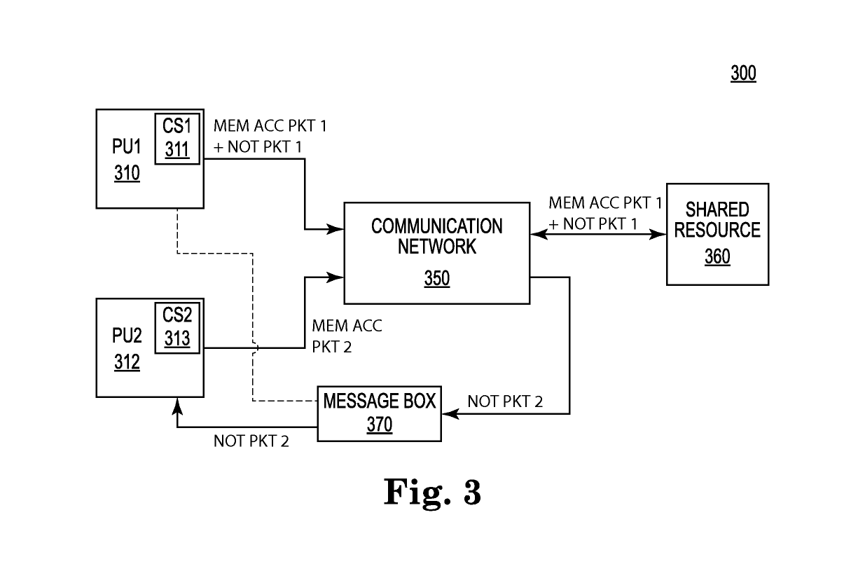

FIG. 3 is a block diagram of an apparatus 300 according to an embodiment of the present disclosure. The apparatus 300 may include a first processor unit 310 and a second processor unit 312, each coupled to a shared resource 360 via a communication network 350. Each of the first processor unit 310 and the second processor unit 312 may store and access data at the shared resource 360. The first processor unit 310 and/or the second processor unit 312 may be implemented in the processor units 110(0-N) of FIG. 1. The shared resource 360 may be implemented in the shared resource 160 of FIG. 1. The communication network 350 may be implemented in the communication network 150 of FIG. 1. The apparatus 300 may further include a message box 370 receiving and storing notification information from notification packets received from the shared resource 360, and providing notification information to the second processor unit 312.

The first processor unit 310 and second processor unit 312 may be formed on single chip, formed on different chips, or combinations thereof. In some embodiments, each of the first processor unit 310 and second processor unit 312 may have an associated cache (e.g., a level 1 cache), and may be configured to operate according to an instruction set architecture (ISA). In some embodiments, the first processor unit 310 and the second processor unit 312 may be homogenous (e.g., are identical processor units). In other examples, the first processor unit 310 and the second processor unit 312 may be heterogeneous (e.g., the processor cores are not identical). Each of the first processor unit 310 and the second processor unit 312 may be designed to perform any function that includes production of data and consumption of data that are stored at the shared memory resource 360.

In some embodiments, the first processor unit 310 and second processor unit 312 may include a respective control space (e.g., the control space 311 and control space 313, respectively). The control space 311 and the control space 313 may be used to control various operational aspects of the first processor unit 310 and the second processor unit 312, respectively. For example, the control space 311 and/or the control space 313 may be configured to store parameters related to operating mode, processing speed, and data flow. In some examples, the control space 311 and/or the control space 313 may be store parameters that provide an indication of when an address location of the shared resource 360 is ready for access. The first processor unit 310 and/or the second processor unit 312 may perform an access of the address location of the shared resource 360 responsive to the indication of the address location being ready to access via the control space 311 or the control space 313, respectively. The control space 311 and/or the control space 313 may be updated to provide the ready for access indication responsive to a notification packet from the shared resource 360 via the communication network 350.

The indication of when an address location of the shared resource 360 is ready for access may be determined from information stored at the message box 370. The message box 370 may receive notification packets from the shared resource 360 that indicate a particular address or addresses of the shared resource 360 are ready to be accessed. The message box 370 may notify the second processor unit 312 that the address location of the shared resource 360 is ready for access by setting a parameter in the control space 313 and/or sending a message to the second processor unit 312. In some embodiments, the first processor unit 310 may also be capable of checking a status of the message box 370 to determine whether to provide additional data to the shared resource 360 for consumption by the second processor unit 312. For example, the message box 370 may include an indicator that that indicates a level of the message box 370. The indicator may indicate empty, half full, full, nearly empty, nearly full, or any combination thereof. The message box 370 may be dynamically updated responsive to completion of access of data associated with an entry of the message box 370 by the second processor unit 312.

The shared resource 360 may include any type of memory, such as non-volatile memory (e.g., NAND or NOR flash, non-volatile random-access memory (RAM), hard drive memory, etc.), volatile memory (e.g., dynamic RAM (DRAM (e.g., double data rate (DDR) static DRAM (SDRAM)), etc.). In some embodiments, the first processor unit 310, the second processor unit 312, and the shared resource 360 are included on the same chip to form a system on chip (SOC). In other embodiments, the first processor unit 310, the second processor unit 312, and the shared resource 360 are on one or more different chips. The shared resource 360 may include a memory controller configured to receive and process access commands from the first processor unit 310 and the second processor unit 312.

The communication network 350 may include a network-on-chip, a local area network (LAN), a personal area network (PAN), system area network (SAN), or another network type capable of providing data and commands between the first processor unit 310, the second processor unit 312, and the shared resource 360. The communication network 350 may operate on a first in, first out basis. Thus, all packets may be provided at an output of the communication network 350 sequentially based on an order of receipt.

In an example operation, the first processor unit 310 and the second processor unit 312 may process data in parallel. The example operation may include the second processor unit 312 accessing data that is generated by the first processor unit 310 and stored at the shared resource 360. That is, the first processor unit 310 may be a producer processor unit (e.g., generate data to be stored at the shared resource 360) and the second processor unit 312 may be a consumer processor unit (e.g., read the data from the shared resource 360). In order to synchronize timing of data storage and data access and reduce probability of processing of incorrect data, the apparatus 300 may include notification system to notify a processor unit that data stored at the memory location available for access.

During execution, the first processor unit 310 may send a write command and write data to the shared resource 360 to perform a write operation. The write command and write data may be sent to the shared resource 360 in a write access packet via the communication network 350. The write access packet may include an address identifying a location of the shared resource 360 to store the data.

Following the write command, the first processor unit 310 may send a first notification packet to the shared resource 360. The first notification packet may include a notification packet type, the address location of the shared resource 360 available for access (e.g., the same address location in the write access packet), and identification of the second processor unit 312. In some embodiments, the notification packet type may include a particular address of the shared resource 360 reserved for this packet type. In other embodiments, the notification packet type may include a flag or another field of the notification packet having a value (e.g., set by the first processor unit 310) that indicates the notification packet type. The identification of the second processor unit 312 may include an address or another field that is decoded to identify the second processor unit 312.

The communication network 350 may provide packets to an output on a first in, first out basis. Thus, the communication network 350 may provide packets received from the first processor unit 310 to a recipient (e.g., the shared resource 360) in a sequential order. A memory controller of the shared resource 360 may be configured to process received packets in a first in, first out basis. Thus, the shared resource 360 may process the write access packet prior to processing the first notification packet. Responsive to receiving the write access packet, the shared resource 360 may store the write data. In some embodiments, the shared resource 360 may verify contents of the write access packet prior to storing the write data.

Responsive to receiving the notification packet, the shared resource 360 may identify the notification packet type, and may retrieve the information identifying the second processor unit 312. The shared resource 360 may construct a second notification packet to send to the message box 370 based on the information identifying the second processor unit 312 and the address location of the shared resource 360. The shared resource 360 may send the second notification packet to the message box 370 via the communication network 350.

In some embodiments, the message box 370 may notify the second processor unit 312 responsive to receiving the notification packet. The notification may include identification of the shared resource 360 location that is available, in some examples. In other examples, the second processor unit 312 may retrieve the shared resource location from the message box 370. In other embodiments, the second processor unit 312 may retrieve the notification packet information from the message box (e.g., via periodic pinging or polling of the message box 370). Responsive to being notified, the second processor unit 312 may send a read access packet with the address location to the shared resource 360. In some embodiments, the control space 313 of the second processor unit 312 may be updated (e.g., clearing or setting of flags or other fields) with information received from the message box 370. The second processor unit 312 may use the information in the control space 313 to determine when to send the read access packet. The message box 370 may be a buffer that is emptied on a first in, first out basis. In some embodiments, the first processor unit 310 may determine a level of the message box prior to writing data to the shared resource 360 to prevent overwriting data yet to be accessed by the second processor unit 312. The level may be provided by a level indicator flag. If the flag indicates the level of the message box is above a particular level, such as half or full, the first processor unit 310 may wait to provide the write access packet or the first notification packet. In some embodiments, the message box 370 may include automatic hazard detection such that notification of a consumer processor unit (e.g., the second processor unit 312) or a producer processor unit (e.g., the first processor unit 310) is limited based on impending hazards associated with a state of the message box 370 itself (e.g., the message box 370 is nearly full and/or nearly empty) or a state of the associated storage in the shared resource 360 (e.g., underflow and/or overflow protection of ring-buffers mapped to the shared resource 360).

The first and second notification packets may be used by the apparatus 300 to synchronize access of data for two or more processor units operating in parallel. The apparatus 300 may be expanded to include any number of processor units. By sending the first notification packets to the shared resource 360, an overhead processing workload for the first processor unit 310 may be reduced as compared with a system where a producer processor unit must monitor a write command request to determine when the write command has completed processing and provide the notification to the second processor unit 312. The above operation is exemplary. A similar operation may be implemented for a read access command may be processed before a write access command for a common address location of the shared resource 360.

In some embodiments, the apparatus 300 may use the message box 370 in such a way that one or multiple producer processor units (e.g., one or multiple of the first processor units 310) may provide a package of data or be processed in the form of descriptors to one or multiple consumer processor units (e.g., one or multiple of the second processor units 312) via the message box 370. Some or all of the one or multiple consumer processor units may receive and/or retrieve information from the message box 370 to process data of the package of data based on workload availability of the individual consumer processor unit. That is, one message box may serve multiple producer and/or multiple consumer processor units in processing of a package of data, rather than just serving one producer and/or one consumer processor unit.

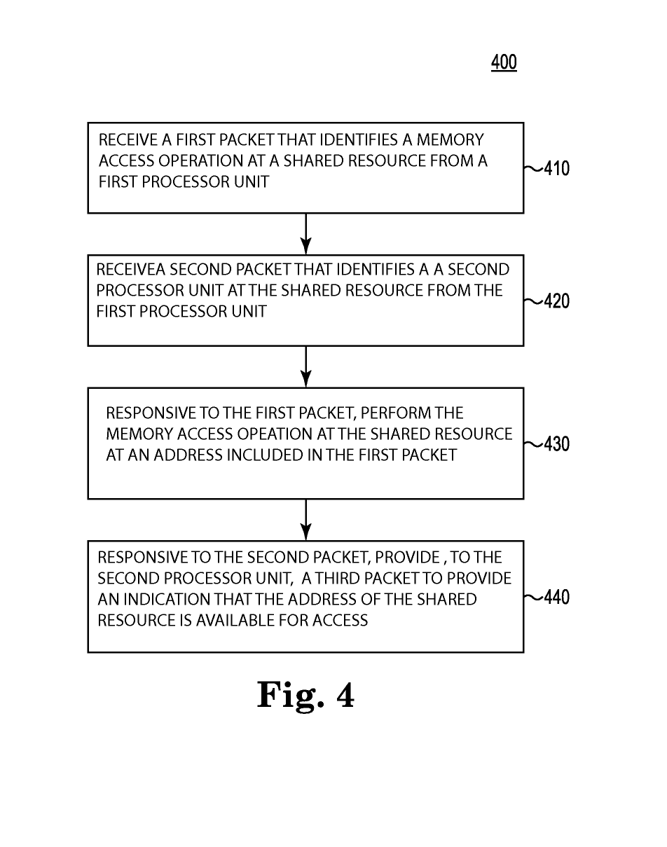

FIG. 4 is flowchart of a method for providing data consistency messaging in a shared memory system according to an embodiment of the present disclosure. The method 400 may be implemented, for instance, the apparatus 100 of FIG. 1, the apparatus 200 of FIG. 2, the apparatus 300 of FIG. 3, or any combination thereof.

The method 400 may include receiving a first packet at a shared resource from a first processor unit, at 410. The first packet may identify a memory access operation associated with the shared resource. The first processor unit may include one of the processor units 110(0-N) of FIG. 1, the first processor unit 210 of FIG. 2, and/or the first processor unit 310 of FIG. 3. The shared resource may include the shared resource 160 of FIG. 1, the shared resource 260 of FIG. 2, and/or the shared resource of FIG. 3.

The method 400 may further include, after receiving the first packet, receiving a second packet at the shared resource from the first processor unit, at 420. The second packet may identify a second processor unit. The second processor unit may include one of the processor units 110(0-N) of FIG. 1, the second processor unit 212 of FIG. 2, and/or the second processor unit 312 of FIG. 3. The method 400 may further include determining a packet type of the second packet. In some embodiments, determining the packet type of the second packet may include reading a value of a flag field of the second packet. In other embodiments, determining the packet type of the second packet may include reading a value of an address field of the second packet.

The method 400 may further include, responsive to the first packet, performing the memory access operation at the shared resource at an address included in the first packet, at 430.

The method 400 may further include providing a third packet to the second processor unit responsive to the second packet, at 440. The third packet may provide an indication that the address of the shared resource is available for access. In some embodiments, providing the third packet to the second processor unit responsive to the second packet may include providing the third packet to a control space of the second processor unit, such as the control space 213 of FIG. 2 and/or the control space 313 of FIG. 3. In other embodiments, providing the third packet to the second processor unit responsive to the second packet may include providing the third packet to a message box associated with the second processor unit. The message box may include the message box 370 of FIG. 3. The message box may be configured to provide information associated with the third packet to the second processor unit, for example responsive to receiving the third packet or based on a request from the second processor unit.

Prior to providing the third packet, the method 400 may further include generating the third packet to provide the indication that the address of the shared resource is available for access responsive to determining that the second packet is a notification packet. In some embodiments, generating the third packet to provide the indication that the address of the shared resource is available for access may include routing the third packet to the second processor unit responsive to identification of the second processor unit in the second packet.

The method 400 may further include receiving a fourth packet at the shared resource from the second processor unit after providing the third packet. The fourth packet may identify a second memory access operation associated with the shared resource. The method 400 may further include responsive to the fourth packet, performing the second memory access operation at the shared resource at an address included in the fourth packet. The address included in the fourth packet may be the same address as the address included in the first packet.

The method 400 may be implemented by a field-programmable gate array (FPGA) device, an application-specific integrated circuit (ASIC), a processing unit such as a central processing unit (CPU), a digital signal processor (DSP), a controller, another hardware device, a firmware device, or any combination thereof. As an example, the method 400 of FIG. 4 may be implemented by a computing system using, for example, one or more processing units that may execute instructions for performing the method that may be encoded on a computer readable medium. The processing units may be implemented using, e.g. processors or other circuitry capable of processing (e.g. one or more controllers or other circuitry). The computer readable medium may be transitory or non-transitory and may be implemented, for example, using any suitable electronic memory, including but not limited to, system memory, flash memory, solid state drives, hard disk drives, etc. One or more processing units and computer readable mediums encoding executable instructions may be used to implement all or portions of encoders or encoding systems described herein.

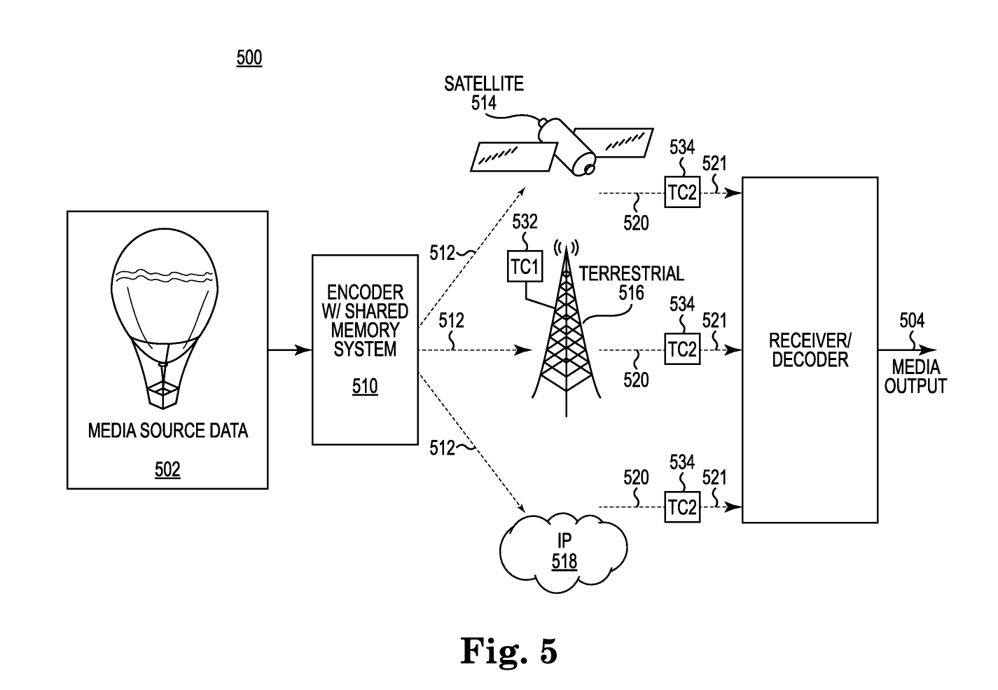

FIG. 5 is a schematic illustration of a media delivery system 500 in accordance with embodiments of the present disclosure. The media delivery system 500 may provide a mechanism for delivering a media source 502 to one or more of a variety of media output(s) 504. Although only one media source 502 and media output 504 are illustrated in FIG. 5, it is to be understood that any number may be used, and examples of the present disclosure may be used to broadcast and/or otherwise deliver media content to any number of media outputs.

The media source data 502 may be any source of media content, including but not limited to, video, audio, data, or combinations thereof. The media source data 502 may be, for example, audio and/or video data that may be captured using a camera, microphone, and/or other capturing devices, or may be generated or provided by a processing device. Media source data 502 may be analog and/or digital. When the media source data 502 is analog data, the media source data 502 may be converted to digital data using, for example, an analog-to-digital converter (ADC). Typically, to transmit the media source data 502, some mechanism for compression and/or encryption may be desirable. Accordingly, an encoder with shared memory system 510 may be provided that may filter and/or encode the media source data 502 using any methodologies in the art, known now or in the future, including encoding methods in accordance with video standards such as, but not limited to, MPEG-2, H.264, HEVC, or combinations of these or other encoding standards. The encoder with shared memory system 510 may be implemented with embodiments of the present disclosure described herein. For example, the encoder with shared memory system 510 may be implemented using the apparatus 100 of FIG. 1, the apparatus 200 of FIG. 2, the apparatus 300 of FIG. 3, and may be configured to perform the method 400 of FIG. 4, or any combination thereof

The encoded data 512 may be provided to a communications link, such as a satellite 514, an antenna 516, and/or a network 518. The network 518 may be wired or wireless, and further may communicate using electrical and/or optical transmission. The antenna 516 may be a terrestrial antenna, and may, for example, receive and transmit conventional AM and FM signals, satellite signals, or other signals known in the art. The communications link may broadcast the encoded data 512, and in some examples may alter the encoded data 512 and broadcast the altered encoded data 512 (e.g. by re-encoding, adding to, or subtracting from the encoded data 512). The encoded data 520 provided from the communications link may be received by a receiver 522 that may include or be coupled to a decoder. The decoder may decode the encoded data 520 to provide one or more media outputs, with the media output 504 shown in FIG. 5. The receiver 522 may be included in or in communication with any number of devices, including but not limited to a modem, router, server, set-top box, laptop, desktop, computer, tablet, mobile phone, etc.

The media delivery system 500 of FIG. 5 and/or the encoder with shared memory system 510 may be utilized in a variety of segments of a content distribution industry.

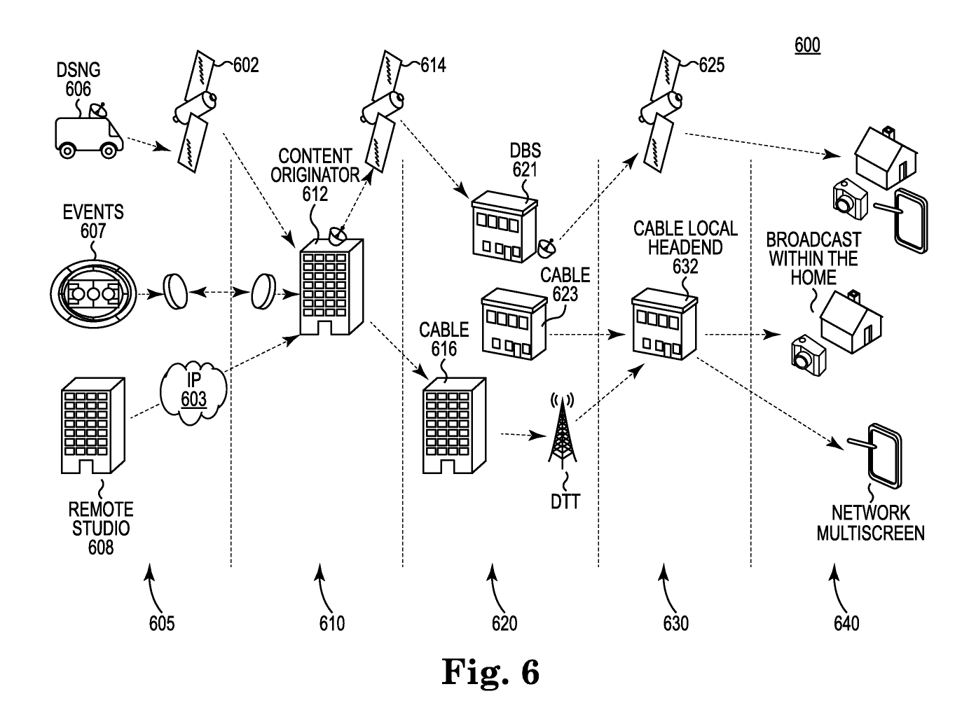

FIG. 6 is a schematic illustration of a video distribution system 600 that may make use of apparatuses described herein. The video distribution system 600 includes video contributors 605. The video contributors 605 may include, but are not limited to, digital satellite news gathering systems 606, event broadcasts 607, and remote studios 608. Each or any of these video contributors 605 may utilize an encoder, such as the encoder with shared memory system 510 of FIG. 5, to encode media source data and provide encoded data to a communications link. The digital satellite news gathering system 606 may provide encoded data to a satellite 602. The event broadcast 607 may provide encoded data to an antenna 601. The remote studio 608 may provide encoded data over a network 603.

A production segment 610 may include a content originator 612. The content originator 612 may receive encoded data from any or combinations of the video contributors 605. The content originator 612 may make the received content available, and may edit, combine, and/or manipulate any of the received content to make the content available. The content originator 612 may utilize encoders described herein, such as the encoder with shared memory system 510, to provide encoded data to the satellite 614 (or another communications link). The content originator 612 may provide encoded data to a digital terrestrial television system 616 over a network or other communication link. In some examples, the content originator 612 may utilize a decoder to decode the content received from the contributor(s) 605. The content originator 612 may then re-encode data and provide the encoded data to the satellite 614. In other examples, the content originator 612 may not decode the received data, and may utilize a transcoder to change a coding format of the received data.

A primary distribution segment 620 may include a digital broadcast system 621, the digital terrestrial television system 616, and/or a cable system 623. The digital broadcasting system 621 may include a receiver, such as the receiver 522 described with reference to FIG. 5, to receive encoded data from the satellite 614. The digital terrestrial television system 616 may include a receiver, such as the receiver 522 described with reference to FIG. 5, to receive encoded data from the content originator 612. The cable system 623 may host its own content which may or may not have been received from the production segment 610 and/or the contributor segment 605. For example, the cable system 623 may provide its own media source data 502 as that which was described with reference to FIG. 5.

The digital broadcast system 621 may include an encoder, such as the encoder with shared memory system 510 described with reference to FIG. 5, to provide encoded data to the satellite 625. The cable system 623 may include an encoder, such as the encoder with shared memory system 510 of FIG. 5, to provide encoded data over a network or other communications link to a cable local headend 632. A secondary distribution segment 630 may include, for example, the satellite 625 and/or the cable local headend 632.

The cable local headend 632 may include an encoder, an encoder, such as the encoder with shared memory system 510 of FIG. 5, to provide encoded data to clients in a client segment 640 over a network or other communications link. The satellite 625 may broadcast signals to clients in the client segment 640. The client segment 640 may include any number of devices that may include receivers, such as the receiver 522 and associated decoder, as described with reference to FIG. 5, for decoding content, and ultimately, making content available to users. The client segment 640 may include devices such as set-top boxes, tablets, computers, servers, laptops, desktops, cell phones, etc.

Accordingly, filtering, encoding, and/or decoding may be utilized at any of a number of points in a video distribution system. Embodiments of the present disclosure may find use within any, or in some examples all, of these segments.

From the foregoing it will be appreciated that, although specific embodiments of the disclosure have been described herein for purposes of illustration, various modifications may be made without deviating from the spirit and scope of the disclosure. Accordingly, the disclosure is not limited except as by the appended claims.

What is claimed is:

1. An apparatus comprising:
a shared memory configured to receive a first packet and a second packet from a first processor unit of a plurality of processor units, responsive to reception of the first packet, the shared memory configured to perform a memory access operation at an address specified in the first packet, responsive to reception of the second packet, the shared memory further configured to route a third packet to a second processor unit of the plurality of processor units based on information included in the second packet, wherein the third packet includes information that indicates that the address of the shared memory is available to be accessed by the second processor unit.

2. The apparatus of claim 1, wherein the shared memory is configured to determine a packet type of the first packet based on a field of the first packet and wherein the shared memory is further configured to determine a packet type of the second packet based the field of the second packet.

3. The apparatus of claim 2, wherein the shared memory is configured to determine the packet type of the second packet based on information included in an address field of the second packet.

4. The apparatus of claim 1, further comprising the first processor unit configured to provide the first packet and the second packet.

5. The apparatus of claim 1, further comprising the second processor unit configured to initiate a memory access operation responsive to receipt of the third packet.

6. The apparatus of claim 5, wherein the second processor unit includes a control space configured to receive the third packet and to provide an indication that the address of the shared memory is available for access.

7. The apparatus of claim 5, further comprising a message box configured to receive the third packet and to provide an indication that the address of the shared memory is available for access to the second processor unit.

8. The apparatus of claim 7, wherein the message box comprises a buffer configured to configured to receive the third packet and to provide an indication that the address of the shared memory is available for access to the second processor unit.

9. An apparatus comprising:
a producer processor unit configured to provide a memory access packet and a first notification packet, the first notification packet including identification of a consumer processor unit;
a shared resource configured to receive the memory access packet and the notification packet, responsive to reception of the memory access packet, the shared resource configured to perform a memory access operation, responsive to reception of the notification packet, the shared resource further configured to route a first notification packet to the consumer processor unit, wherein the second notification packet includes information indicating the shared resource is available.

10. The apparatus of claim 9, further comprising a message box associated with the second processor unit configured to receive the second notification packet.

11. The apparatus of claim 10, wherein the message box is configured to provide indication of availability of the shared resource responsive to reception of the notification packet.

12. The apparatus of claim 10, wherein the message box includes a status flag accessible by the producer processor unit indicating a status of the message box.

13. The apparatus of claim 12, wherein the producer processor unit is configured to wait to send the notification packet until the status flag indicates the message box is below a particular level.

14. A method comprising:
receiving a first packet at a shared resource from a first processor unit, wherein the first packet identifies a memory access operation associated with the shared resource;
after receiving the first packet, receiving a second packet at the shared resource from the first processor unit, wherein the second packet identifies a second processor unit;
responsive to the first packet, performing the memory access operation at the shared resource at an address included in the first packet; and
providing a third packet to the second processor unit responsive to the second packet, wherein the third packet provides an indication that the address of the shared resource is available for access.

15. The method of claim 14, further comprising:
determining a packet type of the second packet; and
generating the third packet to provide the indication that the address of the shared resource is available for access responsive to determining that the second packet is a notification packet.

16. The method of claim 15, wherein determining the packet type of the second packet comprises reading a value of a flag field of the second packet.

17. The method of claim 15, wherein determining the packet type of the second packet comprises reading a value of an address field of the second packet.

18. The method of claim 15, wherein generating the third packet to provide the indication that the address of the shared resource is available for access comprises routing the third packet to the second processor unit responsive to identification of the second processor unit in the second packet.

19. The method of claim 14, further comprising:
receiving a fourth packet at the shared resource from the second processor unit after providing the third packet, wherein the fourth packet identifies a second memory access operation associated with the shared resource;
responsive to the fourth packet, performing the second memory access operation at the shared resource at an address included in the fourth packet, wherein the address included in the fourth packet is the same address as the address included in the first packet.

20. The method of claim 14, wherein providing the third packet to the second processor unit responsive to the second packet comprises providing the third packet to a control space of the second processor unit.

21. The method of claim 14, wherein providing the third packet to the second processor unit responsive to the second packet comprises providing the third packet to a message box associated with the second processor unit, wherein the message box is configured to provide information associated with the third packet to the second processor unit.
